(19) United States
(12) Patent Application Publication
(10) Pub. No.: US 2022/0278960 A1
(43) Pub. Date: Sep. 1, 2022

(54) SYSTEMS AND METHODS FOR DYNAMIC ACCESS CONTROL FOR DEVICES OVER COMMUNICATIONS NETWORKS

(71) Applicant: IP Technology Labs, LLC, Baltimore, MD (US)

(72) Inventors: Gary Mitchell, Owings Mills, MD (US); Scott Whittle, Olney, MD (US); Kurt Quasebarth, Baltimore, MD (US)

(73) Assignee: IP Technology Labs, LLC, Baltimore, MD (US)

(21) Appl. No.: 17/187,094

(22) Filed: Feb. 26, 2021

(51) Int. Cl. H04L 29/06

(52) U.S. Cl. CPC H04L 63/0272; H04L 63/101; H04L 63/0281; H04L 63/0236; H04L 63/0263

(57) ABSTRACT

The invention is that of systems and methods to reduce or eliminate network resource exposure to unauthorized network users. The methods described herein are designed to only permit authenticated remote network device access to central network services based on the content of requests from remote network devices seeking access. A system as described herein is configured with conditional access grantor and request modules located on central and remote networks, respectively. A conditional access grantor module dynamically configures a central network firewall or equivalent to permit or deny access from the specific devices on the remote network. A database is provided for storing of remote device details or parameters supplied by the grantor module and required for connection thereby to the central network. This prevents scanning, duplicate access, man-in-the-middle attacks, DDoS attacks, or access by unauthorized devices commonly taking place on IP networks such as the Internet as only the network parameters of an authorized remote will be able to communicate.

### STATEMENT REGARDING FEDERALLY SPONSORED RESEARCH OR DEVELOPMENT

The invention of the present disclosure was conceived and reduced to practice without the benefit of federal funding.

### BACKGROUND OF THE INVENTION

The invention relates to the technical field of Internet security. When a server or other network appliance is exposed to a network such as the Internet, it becomes accessible to anyone with an Internet access located anywhere. Hacking of network applications (e.g., web servers), distributed denial of service (DDoS) attacks, and password attacks are some examples of what can occur within moments of a valid Internet Protocol (IP) address being accessible via a network.

While firewalls and similar network security-based devices exist, there is no method currently available to automatically and dynamically allow a device to identify its current network parameters (e.g., its source IP address, or its public IP address if it is on a private network behind another router or firewall) so that a headend firewall can “open up” or allow the traffic entrance to the network from that IP address and port. Additionally, the headend firewall may want to signal to the remote network device certain one-time-use connection details to use only for that specification connection. Thus, only those inbound connections that exactly match all those parameters will be permitted. What is missing from the current state of the art is coordination between a remote network device and a headend firewall to relay, authenticate, and configure how a remote device should connect to a central site. It is an object of the invention of the present disclosure to provide a method to establish such coordination.

The invention of the present disclosure accomplishes such coordination by providing attributable security to a network by only allowing network requests and traffic from authorized remote network devices by using the remote devices' specific networking and device parameters. Some examples of such parameters are source and destination IP addresses, protocol type, source or destination port, X509.v3 certificate, VLAN information, and other data within a data packet header or packet body.

### BRIEF SUMMARY OF THE INVENTION

The invention of the present disclosure provides concrete countermeasures to overcome issues of network resource exposure to unauthorized network users. The methods described herein enable the blocking of all access to any and all central network services while only permitting pin-point and one-time-only access that is specific to a remote requesting device and its immediate connection to enable data packet movement between networking applications without regard to protocol.

Remote network parameters are determined at the central site and then used to dynamically configure a firewall or equivalent security system to permit or deny access from the remote network. This type of security enables only communications with known remote devices using the immediate and specific networking details for a single connection. This prevents scanning, duplicate access, man-in-the-middle attacks, DDoS attacks, or access by unauthorized devices. Additionally, a stolen or compromised device's configuration cannot be used to make a connection to a headend, unauthorized remote endpoint as it will not include the connection details it should use to connect to a central site.

### BRIEF DESCRIPTION OF THE DRAWINGS

FIG. 1 illustrates a relationship between remote and central networks and connected devices according to the present disclosure, wherein a request module of a remote network device may post self-identifying information to a database.

FIG. 2 illustrates a relationship between remote and central networks and connected devices according to the present disclosure, wherein a grantor module of a central network device may extract information from a database that has been posted by a remote network device seeking access to the central network.

FIG. 3 illustrates a relationship between remote and central networks and connected devices according to the present disclosure, wherein a connection to a central network device requires processing of remote device information posted to a database by a grantor module of the central network.

FIG. 4 illustrates a relationship between remote and central networks and connected devices according to the present disclosure, wherein a request module of a remote network extracts connection information supplied to a database from a grantor module of central network device.

FIG. 5 illustrates an embodiment of the present invention wherein access by a remote network device to a central network device is enabled directly in accordance with a method according to the present disclosure.

### DETAILED DESCRIPTION OF THE INVENTION

The invention of the present disclosure is that of systems and methods for deterministic access control for network devices over a communication network with the Internet being one example of such a network. A central network device is provided comprising a software module capable of determining selected remote network parameters and causing a connected microprocessor to dynamically configure a firewall or equivalent useful in controlling access from a remote network to, for example, a web server, the module referred to herein as a conditional access grantor module, or simply “grantor module”.

An exemplary system of the invention described herein may include a conditional access request module (“request module”), a grantor module, and a database storing unique identifier (UID) or other pertinent details posted by the request module, each UID being associated with a request module of a device located on a remote network. Under this framework, method steps may be executed to enable dynamic access control for remote devices, over IP and other communications networks such as but not limited to the Internet, seeking to access a central network and obtain services.

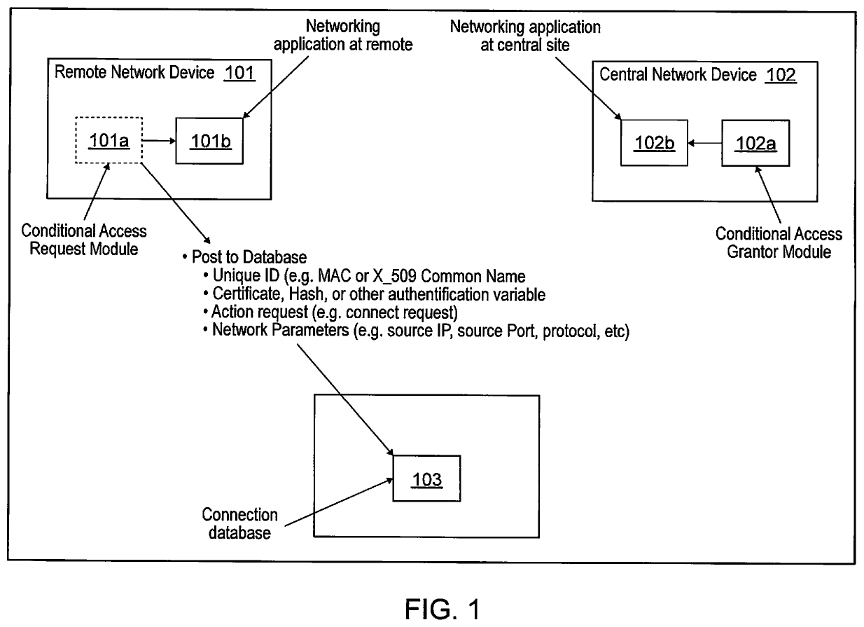

As illustrated in FIG. 1, an exemplary method according to an embodiment of the invention described herein may be initiated when a request module 101a of a remote network device 101 posts its UID information to a database 103. Examples of a UID attributable to a request module 101a of a remote network device 101 as described herein may include, without limitation, a media access control (MAC) address, an X.509 certificate or a common name or extensions; a certificate, hash code, or other authentication variable; an action request (i.e., a request to connect to a central network device 102); network parameter information, for example, a source IP address, a source port identifier, a source protocol; or any other properly formatted identifier that is attributable to the request module 101a, as will be understood by one of ordinary skill in the art.

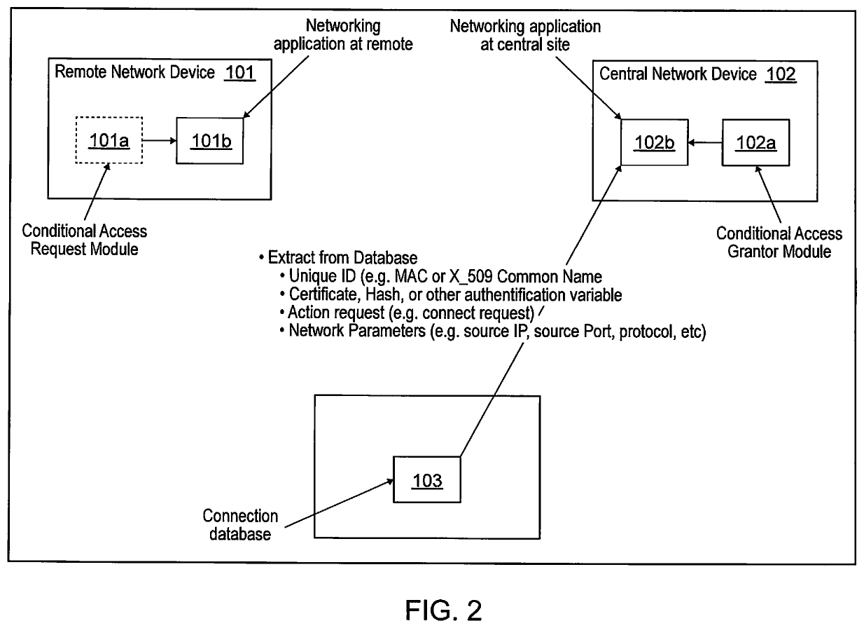

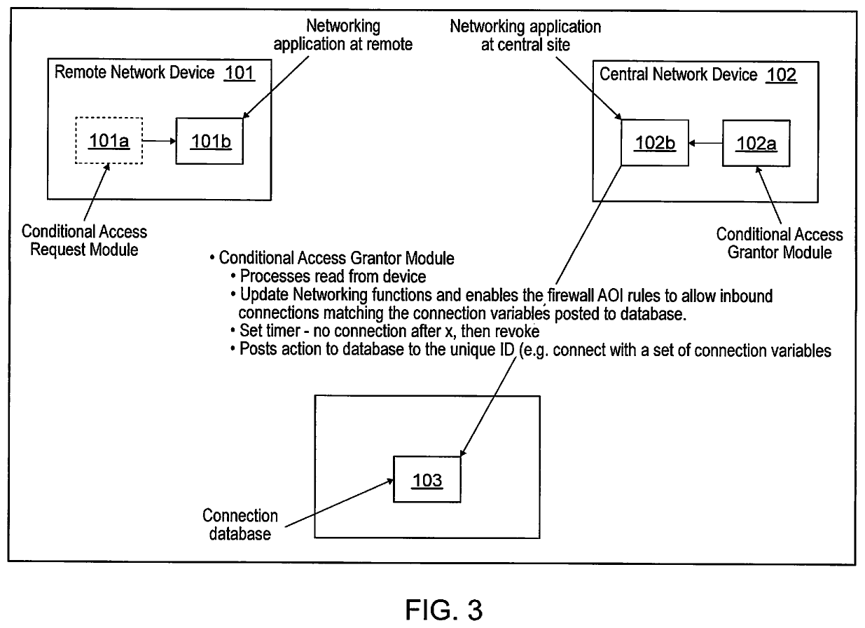

Once a request module UID has been posted to database 103, a central network device 102 located at a central site, comprising a grantor module 102a in network communication with the database 103 according to a system as illustrated in FIG. 2 can then cause a connected microprocessor to extract the posted UID information from the database 103 and generate connection details required for the requesting remote network device 101 to connect to the central network device 102, or simply indicate that the requested connection may proceed without the need for further actions to be taken by the remote device 101. A grantor module 102a as described herein may also update a local networking firewall at the central site or equivalent security feature to permit a connection based on details obtained from the request module 101a, and may optionally generate and communicate additional details required for the requested connection upon receiving the request from the request module 101a, as will be explained further below with reference to FIG. 3.

A central site may represent a headend body of resources to which remote users and their remote network devices need to connect to obtain desired services. For example, in the private enterprise setting, a central office location may represent a central site housing servers, such as but not limited to web servers, that authenticated users may wish to access in order to obtain services and perform tasks. Another example might be a network of web servers acting as a central network for the provision of services such as high-definition television or movie viewing, as is common in the marketplace today.

Turning now to FIG. 3, a grantor module 102a according to certain embodiments of the present invention may, instead of automatically granting access to the central network device 102 on which it resides without additional steps, process information posted to a database 103 by a request module 101a of a remote network device 101 following extraction by the grantor module 102a in order to provide feedback to the request module 101a in the form of details required for establishing a connection with the central network device 102. This method step provides an additional layer of protection against unauthorized access to the central network as the headend defines the one or more connection parameters to be used by remote network device 101. In an exemplary embodiment, a grantor module 102a may update central networking application 102b to enable an access control list (ACL) of a central network firewall to allow inbound remote connections matching connection variables posted by the grantor module 102a to a database 103. In a preferred embodiment, a grantor module 102a may additionally limit the amount of time after the posting of required connection parameters to the database 103 during which a requesting device may connect to the central network, thereby creating a controlled window of time during which the authorized device may obtain access to the central network device 102.

In still other embodiments, a grantor module 102a may be in communication with an intermediate network device (not shown) through a logical connection between the grantor module 102a and a management control interface of the intermediate network device, which may, in response to a signal from the grantor module 102a, perform a switching action in response to instructions transmitted from the grantor module 102a to the intermediate device. In this way, a device external to the central network device 102 may configure firewall rules or equivalent security features of the central network device 102 to allow connections to be established between remote networking application 101b and central networking application 102b.

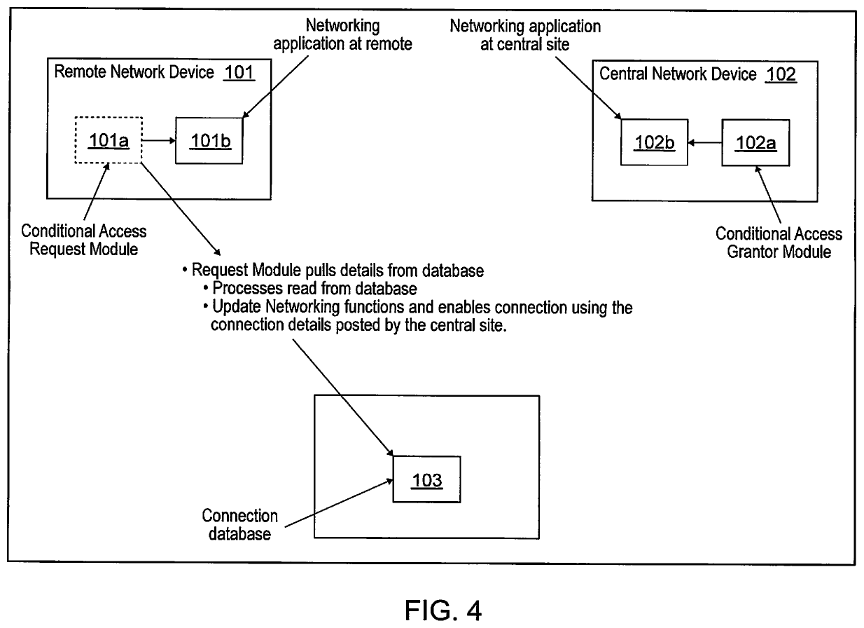

If a grantor module 102a as described herein generates connection details and posts them to the database 103, a request module 101a may then access the database 103 and obtain and process the detail information in order to update its connection and networking details according to the information generated by the grantor module 102a, as illustrated in FIG. 4. Once this is accomplished, the requesting remote networking application 101b can connect to a central networking application 102b using the connection details expected as a result of the grantor module 102a generating said connection details and communicating the same to the central networking application 102b.

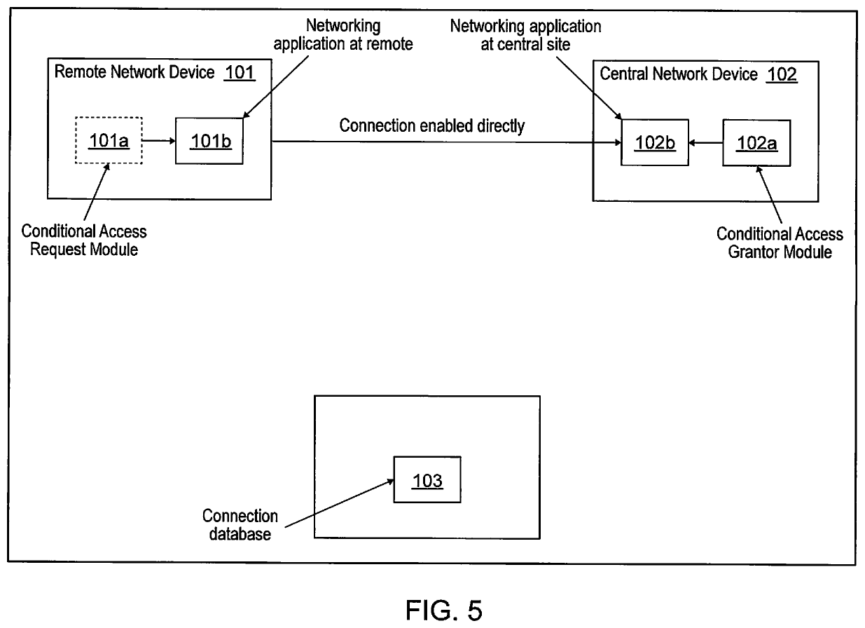

Turning now to FIG. 5, a system according to the various embodiments of the present disclosure may allow for a direct connection between a remote network device 101 and central network device 102 based on recognition of valid credentials supplied from a remote networking application 101b to a central networking application 102b in communication with the grantor module 102a. That is, after the request module 101a posts a UID, grantor module 102a configures a central network firewall or other security feature, and request module 101a provides any required connection details within the time allotted by the grantor module 102a, remote networking application 101b and central networking application 102b may establish secure communication between remote network device 101 and central network device 102.

These and other methods enabled by a system as described herein allow for secure connections between endpoints on disparate networks that is direct, from endpoint to endpoint, thereby eliminating other points in the communication path that might otherwise subject the network devices involved from hacking, DoS attacks, man-in-the-middle attacks, spoofing and other nefarious activities taking place commonly in the context of Internet communications. The invention described herein affords network administrators with an additional security tool useful for preserving network integrity and deterministic network access control.

Moreover, embodiments of the systems and methods according to the present disclosure are compatible with multiple communications data exchange protocols familiar to those of ordinary skill in the art, including but not limited to connection-oriented protocols such as Transmission Control Protocol (TCP), or connectionless protocols such as IP or the User Datagram Protocol (UDP) and combinations of such known protocols (e.g., TCP/IP). It is an object of the invention to provide for secure data packet movement between applications regardless of the protocol in which connectivity is implemented. These and other advantages will be evident to those of ordinary skill in the art in view of the illustrative embodiments presented and described herein.

What is claimed:

1. A system for access control for applications over communications networks, the system comprising:
a remote network device comprising a request module and a networking application in communication therewith;
a central network device comprising a grantor module and a central networking application in communication therewith; and
a database;
wherein the request module comprises instructions which when executed by a connected microprocessor cause the microprocessor to post information unique to the request module to the database and the grantor module comprises instructions which when executed by a connected microprocessor cause the microprocessor to extract the information from the database and configure a security means of the central network device to permit the remote network device to access the central network device.

2. The system of claim 1, wherein the grantor module further comprises instructions which when executed by a connected microprocessor cause the microprocessor to process the extracted information and post additional connection requirements to the database; and
the request module further comprises instructions which when executed by a connected microprocessor cause the microprocessor to extract the connection requirements from the database, transmit the additional connection requirements to the central network device and establish communication between the remote network device and the central network device.

3. The system of claim 1, wherein the security means is selected from the group consisting of a firewall, a router, a network switch, a network security application or combinations thereof.

4. The system of claim 2, wherein the security means is a firewall, a router, a network switch, a network security application or combinations thereof.

5. The system of claim 1, wherein data transport within the communications networks is selected from the group consisting of connection-oriented, connectionless and combinations thereof.

6. The system of claim 2, wherein data transport within the communications networks is selected from the group consisting of connection-oriented, connectionless and combinations thereof.

7. The system of claim 3, wherein data transport within the communications networks is selected from the group consisting of connection-oriented, connectionless and combinations thereof.

8. The system of claim 4, wherein data transport within the communications networks is selected from the group consisting of connection-oriented, connectionless and combinations thereof.

9. A method of controlling access to applications over communications networks, the method comprising:
posting information from a request module of a remote network device to a database;
extracting the posted information to a grantor module of a central network device; and
configuring a security means of the central network device to permit access thereto by the remote network device based on the information extracted to the grantor module

10. The method of claim 9, wherein the security means is a firewall, a router, a network switch, a network security application or combinations thereof.

11. The method of claim 9, wherein the remote network device is permitted to access the central network device only during a fixed timeframe.

12. The method of claim 9, wherein data transport within the communications networks is selected from the group consisting of connection-oriented, connectionless and combinations thereof.

13. The method of claim 9, further comprising the step of posting additional requirements from the grantor module to the database based on the security rules of the central network device;
extracting the additional connection requirements to the request module; and
forwarding said connection requirements from through a connected remote networking application to a central networking application, thereby obtaining access to the central network device.

14. The method of claim 13, wherein access to the central network devices is selected from the group consisting of connection-oriented, connectionless and combinations thereof.

15. The method of claim 14, wherein the security rules are firewall rules.

16. The method of claim 14, wherein the access to the central network device is only permitted during a fixed timeframe.
